(19) United States
(12) Patent Application Publication
(10) Pub. No.: US 2005/0125843 A1
(43) Pub. Date: Jun. 9, 2005

(54) Television viewer/studio interactive commentary

(76) Inventors: Charles E. Okezie, Detroit, MI (US); Tanya Elizabeth Thomas, Detroit, MI (US)

Correspondence Address: Charles E. Okezie, 14350 St. Marys, Detroit, MI, 48227, US

(21) Appl. No.: 10/972,933

(22) Filed: Oct. 23, 2004

Related U.S. Application Data
(60) Provisional application No. 60/517,758, filed on Nov. 5, 2003.

(51) Int. Cl. H04N 7/173; H04N 11/00; H04N 7/00; H04N 7/16

(52) U.S. Cl. 725/133; 725/141; 725/153; 348/552

(57) ABSTRACT

Televisions, computers, computer devices, facsimile machines, radios, telephones, walkie-talkies, are used to view, listen to and communicate with individuals in the television studio who, as the secondary program, are watching a primary program (sports, news, commercials, awards, etc.) and discussing those events along with any other topic they choose to. The listening/viewing audience is able to enjoy the primary and secondary programs with two televisions, or one television with picture in picture capability, or a television and a computer. The secondary program commentators and viewing/listening audience may use phones, walkie-talkies, computers, computer devices, and facsimile machines to communicate with each other concerning the primary programming, which could consist of any life event or topic they choose.

### CROSS-REFERENCE TO RELATED APPLICATIONS

This application claims the benefit of provisional patent application Ser. No. 60/517,758, filed 2003 Nov. 5 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to a group of individuals viewing and listening to a particular program along with interactive commentary with the general audience, whilst the program is in progress, creating a new form of broadcast entertainment.

2. Prior Art

The advent of the new technology and televisions necessitates and makes inevitable, creation of new forms of broadcast entertainment. The closest related art to our invention would be radio commentators who comment on a sporting event they are watching, as it happens. Nevertheless, that occurs without general audience interaction and participation as described below. On the radio, news of the sporting events is simply relayed to the listener. As with the television commentators and analyst there is virtually no real criticisms of game officials, coaches, players, and owners, etc. Commentary is always politically correct and not reflective of the attitudes, behaviors, and demeanors of the average “Joe football fan”, for example.

In our invention, the studio commentators are not discussing or describing the principle programs' events, as they occur in order to relay information to the viewer as in radio and present sports analysts and newscasters. Instead, they are subjectively commenting on the principle program and other topics they are aware the viewing audience is also able to observe and have their own thoughts and feelings about.

Presently, television commentators and analysts are prohibited from criticizing officiating, coaches, players, fans, etc., harshly. In our invention, the commentators and viewership may voice their opinions openly and if they feel a referee is “cheating”, they may speak their feelings as just that. Situations will mirror real home, stadium, or friendship situations where there are many arguments on inconsequential facts or subjects. Arguments and discussions would ensue on college football split national championships of 1999 (Michigan & Nebraska) and 2004 (U.S.C. and L.S.U.), college playoff systems, tastes great/less filling, TV commercials, current events, town gossips, who the best quarterback is, etc.

Rush Limbaugh, Jimmy “The Greek” Snyder and other causalities of politically correct sports commentating would not have been fired had this invention been in place and would have benefited from the freedom they would have been allowed to voice personal opinions (whether heavy criticism would have followed or not). The style and openness in which topics are debated, along with the participants and forum is a new creation of entertainment.

### OBJECTS OF THE INVENTION

The main object of the present invention is to provide simultaneous viewing/listening for a particular program (the principle program that includes commercials), along with interactive commentary with the general audience, whilst the program is in progress creating a new form of broadcast entertainment.

This new form of entertainment allows the general audience to experience the principle program as if he/she were actually watching with other friends, with all the comfort and convenience of home or whatever setting they choose.

This objective can be accomplished by:
1.) Obtaining two TVs or one TV with picture in picture capability
2.) Radio
3.) Telephone
4.) Computer
5.) Fax machine
6.) Television Studio
7.) Radio Station
8.) Software Program
   The TVs and computer would be used to watch the principle program and the commentary from a studio as the secondary program, simultaneously. Telephones, computers, radios, and fax machines would allow the viewing audience to interact with the secondary programs commentators by video mail, calling, sending e-mail, or fax in real time with the principle program. The commentators would rotate on a regular basis.

The convenience, comfort and security of a home setting (or other chosen environment), together with the style of the studio commentators and the manner in which they discuss subjects, plus the fact that the subject is another broadcast television programming option, or any number of other issues, and that the viewers, in effect, become studio commentators and therefore part of the entertainment, makes this new form of entertainment appealing.

### SUMMARY OF THE INVENTION

This invention relates, in general, to a group of individuals (friends, acquaintances, married, single, religious affiliations, etc.), watching a scheduled or live program (sports event, talk show, competition, music videos, TV shows, movies, commercials, news, etc.) and commenting on it while it is still in progress and afterwards. This can be accomplished via two TVs or a TV with picture in picture capability, a radio, telephone, facsimile machine, or computer.

Part of the attraction in attending live events or watching events with others, is the feeling of involvement and participation. This invention provides greater simulation of those feelings with all the conveniences of home, or whatever setting the viewer chooses. The studio commentators are, in effect, other fans or viewers of the same principle program and are interacting with the home or viewing audience by phone, computer, fax, walkie-talkie, or mail.

The standard method of broadcast commentary is performed before, after, or in between (during commercials) of the scheduled program and is limited to sports events. The commentator is most often a professional analyst, critic, or expert in the field presenting the event or program in a preview, news or commentary format, and mainly giving facts and information, not much personal opinion.

In our invention, some commentators would actually take sides during sporting events and other issues and make comments not related to the programming. This invention allows for mainly non-professional commentators who discuss the principle program, being viewed by both they and the general audience, in non-professional and professional manners, in laymen terms and are rife with personal opinions, and non-constructive criticisms.

Standard commentators provide previews, analyses, facts, figures, credible information, technical comparisons, in professional manners. The commentators in this invention provide the same but also with sarcasm, exaggeration, incredibility, argumentative, natural emotion, etc. The general audience, whilst viewing, may provide commentary and input in real time. The television studio, studio employees, the viewer audience, the discussions and commentary forum and the program(s), situations, happenings, events, topics being discussed and commented upon combined, creates another form of entertainment.

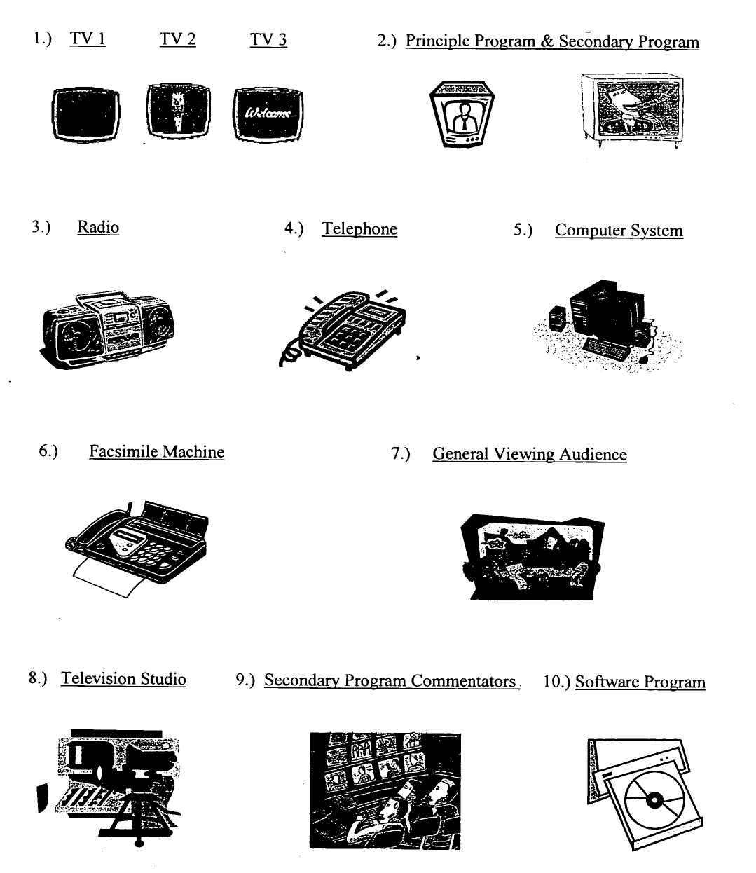

FIG. 1: shows two TVs and a third TV with picture in picture capability.

FIG. 2: shows the principle programs and the secondary program of which the general viewing audience will be viewing simultaneously.

FIG. 3: shows a radio.

FIG. 4: shows a telephone.

FIG. 5: shows a computer system.

FIG. 6: shows a fax machine.

FIG. 7: refers to the general viewing audience.

FIG. 8: shows a television studio.

FIG. 9: refers to the secondary program commentators.

FIG. 10: refers to a software program containing a method of screening viewer/commentator communication and interactions.

### DETAILED DESCRIPTION OF INVENTION

Referring now to FIG. 1, which is an overall drawing of a preferred embodiment of the invention. It shows a new form of broadcast entertainment compromising of main functional components 1 through 9.

1.) Shows three TVs, TV 1 and TV 2 would be used to view a principle program and the secondary program (the commentary) simultaneously. TV 3 possesses picture in picture capability and would be used to view the principle program secondary program simultaneously a fourth, fifth, sixth,

2.) Refers to the principle programs and the secondary program. The viewing audience will watch both programs simultaneously on two televisions or more, a TV with a picture in picture capability, or a computer and TV format with the secondary program being on the computer or vise versa.

The principle program refers to whatever event, show, news, sports, etc. is on television that the secondary program commentators are watching. To participate the viewership would tune into both the principle program channel and the secondary program channel.

The secondary program refers to a television studio producing a show in which individuals are employed to watch the principle program react naturally and openly and interact with the viewing audience concerning the principle and any other topics that arise.

3.) Shows a radio, which would be used to listen to the secondary programs' commentators on the principle program that is on TV or on whatever subjects is being discussed.

4.) Shows a telephone, which would be used by the viewers and the secondary program commentators to communicate opinions, comments, remarks, opinions, facts, thoughts, etc., to each other during their commentary on the primary program or other subjects and topics of discussion.

5.) Shows, (A) a computer system which would be used by the secondary programs commentators, and the viewing audience, to communicate messages, points, opinions, thoughts, comments, during the time of the principle and secondary program, via e-mail or video e-mail.

(B) a computer, which is used to view and listen to the secondary programs' commentators' commentary on the principle program and other topics of discussion.

6.) Shows a facsimile machine, which would be used by the viewers to fax, letters, pictures, material, and comments to the shows commentators.

7.) Refers to viewers who would watch both the live commentary on the secondary program concerning the principle program and other topics, and the principle program itself.

8.) Shows a television studio where the secondary program show will be produced.

9.) Refers to the individuals hired as commentators at the secondary programs' studio.

10.) Refers to a software program used by the studios' operators to screen viewer/commentator interaction for content and appropriateness. Interaction and communications have to be relevant and appropriate to the show.

An individual or an group of individuals (the secondary program) watching a sporting event, talk show, competition (chess match, game show, etc.) music videos, commercials, TV show, movie, sit com, soap opera, or other event or programming (the primary or principle or subject program) and providing commentary in various forms (entertainment, previews, analysis, sarcasm, etc.) simultaneously with the principle program. The viewing audience watches the principle and secondary program simultaneously on two TVs, or one TV with picture in picture capability, or on a TV and a computer screen. The secondary programs' commentators provide commentary, or entertainment throughout the show (including during the commercials), the viewing audience phone in, fax in or e-mail comments, information, facts, figures, opinions, statements, etc. The viewers' commentators and interactions with the commentators are screened manually by studio employees and by computer software, for relevancy and appropriateness to the show. The commentators could be representative of the particular locality or region of viewership and could change on a regular basis (weekly, biweekly, monthly, etc.), with the most popular returning for more shows. Potential commentators would be auditioned from the public. Others would be celebrities and some would be industry professionals.

The foregoing description of the preferred embodiment of the invention has been presented for the purposes of illustration and description. It is not intended to be exhaustive or to limit the scope of the invention to the precise form disclosed. Numerous modifications, variations, and substitutions are possible without departing from the invention herein. Accordingly, it is intended that the invention be limited only by the spirit and scope of the appended claims.

1.) A method of creating a new form of entertainment comprising of two TVs or one TV with picture in picture capability, which are used to view two programs simultaneously, the subject program in its secondary commentary program.

2.) A computer, which is used to view commentators live commentary on the principle program as it, proceeds.

3.) A radio, which would be used to listen to the secondary programs commentary on the subject program on TV, simultaneously.

4.) Telephones, which will be used by the viewing audience and secondary programs commentators to communicate opinions, remarks, thoughts, facts, etc., to the shows commentators during their live commentary on the subject program.

5.) A computer system, which would be used by the viewers and the shows commentators to communicate messages, comments, points, opinions, thoughts, remarks, etc., via e-mail or video e-mail.

6.) Facsimile machines, which would be used by the viewers or commentators to fax material, letters, pictures, comments, messages, facts, etc. to each other during their live commentary on the subject program.

7.) The viewing audience of the principle program and secondary program.

8.) A television studio where the secondary program would be produced.

9.) Individuals who are hired as commentators on the secondary program.

10.) A television or radio program (which would also be available on computer monitors) of claims one through nine, consists of commentators who comment on some principle/subject program as both proceeds in real time.

11.) A viewing audience that calls in, logs on, or faxes in material, information, facts, comments, remarks, messages, opinions, thoughts, pictures, letters, etc., interacting and communicating with the secondary programs commentators and real time whilst also watching the primary program.

12.) A software program containing a method of screening and accepting the viewer/commentator communication interactions of claim 5.
